(19) United States
(12) Patent Application Publication
(10) Pub. No.: US 2023/0268569 A1
(43) Pub. Date: Aug. 24, 2023

(54) CHARGING AND DISCHARGING COMPONENTS, BATTERIES AND BATTERY MODULES

(71) Applicants: ZHEJIANG NARADA POWER SOURCE CO., LTD., Hangzhou (CN); HANGZHOU NARADA POWER TECHNOLOGY CO., LTD., Hangzhou (CN)

(72) Inventors: Yinglai WANG, Hangzhou (CN); Feng GUO, Hangzhou (CN); Yanhong LI, Hangzhou (CN); Qinxu JIANG, Hangzhou (CN); Jing MA, Hangzhou (CN); Liukou XU, Hangzhou (CN); Wen HUANG, Hangzhou (CN); Ling FANG, Hangzhou (CN)

(73) Assignees: ZHEJIANG NARADA POWER SOURCE CO., LTD., Hangzhou (CN); HANGZHOU NARADA POWER TECHNOLOGY CO., LTD., Hangzhou (CN)

(21) Appl. No.: 18/308,834

(22) Filed: Apr. 28, 2023

Related U.S. Application Data
(63) Continuation of application No. PCT/CN2022/075687, filed on Feb. 9, 2022.

(51) Int. Cl. H01M 10/44; H01M 10/0525; H01M 50/54; H01M 50/536

(52) U.S. Cl. CPC H01M 10/44; H01M 10/0525; H01M 50/54; H01M 50/536

(57) ABSTRACT

A charging and discharging assembly, a battery core and a battery module are provided in the disclosure, which are applied in a lithium ion battery. The charging and discharging unit includes a positive electrode plate including positive tabs, a negative electrode plate including negative tabs, and a separator for separating the positive electrode plate and the negative electrode plate. The positive tab at least includes a first positive tab and a second positive tab, and the negative tab at least includes a first negative tab and a second negative tab. The positive electrode plate, the separator and the negative electrode plate are stacked with each other. The positive tabs and the negative tabs are respectively shifted to same sides of the positive electrode plate and the negative electrode plate.

### CROSS-REFERENCE TO RELATED APPLICATION

This application is a continuation of International Application No. PCT/CN2022/075687, filed 9 Feb. 2022, the benefit of priority of which is claimed herein and which application is hereby incorporated by reference herein in its entirety.

### TECHNICAL FIELD

The disclosure relates to the technical field of lithium ion batteries, and more particularly relates to a charging and discharging assembly, a battery core and a battery module.

### BACKGROUND ART

Lead-acid batteries are widely used in various fields because of their low price, easy access to raw materials and reliable performance. However, due to their low specific energy and short cycle life, the application fields of THE lead-acid batteries are limited.

Lithium-ion batteries have a high single-cell terminal voltage, high specific energy, long cycle life and environmental protection, which can just overcome shortcomings of the lead-acid batteries. Existing charging and discharging assemblies are classified into a wound type or a stacked type. A wound-type assembly is with a simpler process and is easier to operate, which is easy to realize industrial automation. At present, most enterprises in the market adopt the wound type. However, internal resistance of the wound-type assembly is high, and with a short battery life. This is because there is only one-way heat transfer between a pole piece and a separator in a wound battery, which leads to serious temperature gradient distribution, high internal temperature and low external temperature, thus affecting the battery life. Furthermore, stressed area among a battery core, a pole piece and a separator in a stacked battery is consistent, with no obvious stress concentration point, and the stacked battery is with high rate capability, capacity and density.

Because of complicated process steps of the stacked battery, it is difficult to achieve good consistency, which is also an important factor limiting wide application of the stacked battery.

At present, a tab is lead out in a full-tab or single-tab manner in the lithium ion battery. Even though a few people have tried a double-tab, it is done in a wound lithium battery, that is, a tab is lead out of a single charging and discharging unit and the double-tab is formed when charging and discharging assemblies are connected in parallel. However, in the stacked lithium ion battery, the double-tab has not been tried for its uniformity.

### SUMMARY

In order to overcome at least one of shortcomings in related art, a stacked charging and discharging unit, a battery core and a battery module with good uniformity are provided in this disclosure.

In order to achieve the above purpose, a charging and discharging assembly applied in a lithium ion battery is provided in this disclosure, which includes a positive electrode plate including positive tabs, a negative electrode plate including negative tabs, and a separator for separating the positive electrode plate and the negative electrode plate. The positive tabs at least include a first positive tab and a second positive tab which are electrically connected with each other, and the negative tabs at least include a first negative tab and a second negative tab which are electrically connected with each other. The positive electrode plate, the separator and the negative electrode plate are stacked with each other. The positive tabs and the negative tabs are respectively shifted to same sides of the positive electrode plate and the negative electrode plate.

More specifically, the positive tabs including at least the first positive tab and the second positive tab are shifted to one side of the positive electrode plate, and the negative tabs including at least the first negative tab and the second negative tab is shifted to one side of the negative electrode plate, and the positive tabs and the negative tabs are both located at same sides of the stacked positive and negative electrode plates. With provision of this structure, uniformity of the charging and discharging assembly, the battery core and the like can be improved.

It is generally believed by the skilled in the art that “providing a tab body in a middle of an upper end of the tab body can improve uneven current distribution caused by a shifted tab”, as described in Chinese utility model publication NO. CN208637499U. However, with unique structural arrangement, the applicant found that with arrangement of at least two tabs in the positive electrode plate or the negative electrode plate and all tabs being shifted to same sides of the positive electrode plate and the negative electrode plate, consistency can be increased, and technical prejudice of the skilled in the art can be overcome.

Optionally, both the positive and negative electrode plates have a central axis, and the positive tabs are located at one side of the central axis of the positive electrode plate and the negative tabs are located at the other side, opposite to the one side, of the central axis of the negative electrode plate, that is, after being stacked, the positive and negative tabs are respectively located at both sides of a central axis of the charging and discharging assembly, and the positive tabs and the negative tabs are respectively arranged in sequence along a top side of the positive electrode plate or negative electrode plate, for example, in an order of the first positive tab, the second positive tab, the second negative tab, and the second negative tab.

Optionally, the positive tabs are shifted to one side of the central axis of the positive electrode plate, and the negative tabs are shifted to the other side, opposite to the one side, of the central axis of the negative electrode plate. More specifically, a central symmetry axis for all positive tabs is not coincident with a quarter axis of the positive electrode plate, and a central symmetry axis for all the negative tabs is not coincident with a quarter axis of the negative electrode plate. Further, the central symmetry axis for all the positive tabs is located at a side of the quarter axis of the positive electrode plate away from the negative tabs, and the central symmetry axis for all negative tabs is located at a side of the quarter axis of the negative electrode plate away from the positive tabs, with a shifted distance being half of a gap between the positive tabs, or more or less.

Optionally, the first positive tab is further away from the central axis of the positive electrode plate than the second positive tab, a distance between the first positive tab and the positive electrode plate is a first distance, a distance between the first positive tab and the second positive tab is a second length, the first length is smaller than the second length, and a distance between the first positive tab and an edge of the positive electrode plate is small. A distance between the second positive tab and the central axis of the positive electrode plate is a third length, the second length is smaller than the third length, and a distance between the second positive tab and the central axis is large.

Optionally, the central axis of the positive electrode plate coincides with the central axis of the negative electrode plate, the first negative tab is further away from the central axis of the negative electrode plate than the second negative tab, and the first negative tab and the first positive tab are symmetrically arranged to the central axis, and a gap between the first negative tab and the second negative tab is equal to the second length, and a gap between the positive tabs is equal to a gap between the negative tabs.

Optionally, widths of the first negative tab and the second negative tab are not the same, which can not only ensure a total width to meet overcurrent requirement, but also avoid a interference risk from sizing.

Optionally, the negative tab is larger in width near the central axis than that near an edge of the negative electrode plate.

Optionally, there are a plurality of positive electrode plates and negative electrode plates, all the first positive tabs are electrically connected with each other, all the second positive tabs are electrically connected with each other, all the first negative tabs are electrically connected with each other, and all the second negative tabs are electrically connected with each other. Optionally, corresponding first positive tabs, second positive tabs, first negative tabs and second negative tabs to different positive or negative electrode plates are all the same, so the corresponding first positive tabs, second positive tabs, first negative tabs and second negative tabs are stacked to form a first positive tab group, a second positive tab group, a first negative tab group and a second negative tab group respectively. The tabs can be crimped, welded or bonded.

Optionally, a top side of the positive electrode is provided with a ceramic insulating layer, with a thickness from 0.5 mm to 8 mm, which can be 1 mm, 2 mm, 3 mm, 4 mm, 5 mm, 6 mm, 7 mm, etc.

Optionally, positive electrode plates, negative electrode plates and separators in a same charging and discharging assembly are all the same, that is, with a same size, shape, material, structure and so on.

A battery core is further provided in this disclosure, which includes arbitrary two of the charging and discharging assemblies electrically connected with each other, and a connecting piece for connecting different charging and discharging units. The connecting piece includes a main region and at least two connecting arms. The at least two connecting arms are electrically connected with the main region respectively, and at least one of the at least two connecting arms is connected with a positive tab or a negative tab of one of the charging and discharging assemblies, and at least another of the at least two connecting arms is connected with a positive tab or a negative tab of another of the charging and discharging assemblies.

Optionally, there are even number of connecting arms, and the connecting arms extend from the main region, and part of the connecting arms are connected with one of the charging and discharging assemblies, and other parts of the connecting arms or all of the rest connecting arms are connected with the other of the charging and discharging assemblies. There may be two, four, six, eight or other number of connecting arms.

Optionally, there are four connecting arms, and the four connecting arms extend from the main region, and two of the connecting arms are connected with one of the charging and discharging assemblies, and the other two of the connecting arms are connected with the other of the charging and discharging assemblies.

Optionally, the two connecting arms connected with a same charging and discharging assembly are located on a same straight line, which can increase effective contact area, and there is a gap between connecting arms connected with different charging and discharging assemblies.

Optionally, a groove is provided at a position of the main region corresponding to the gap.

Optionally, a positive connecting piece is configured for connecting with the positive tab, and a fuse hole is provided between the main region and the connecting arms of the connecting piece for the positive tab.

Optionally, the connecting piece for the negative tab is configured for connecting with the negative tab, and the main region of the negative tab connecting piece is pitted.

Optionally, a height of the positive tab is greater than a width of the connecting arm connected therewith.

Optionally, the battery core further includes a top cover, more than two charging and discharging assemblies are connected by butterfly welding, the connecting piece is welded with the top cover, and the top cover is provided with a third-order platform liquid injection hole.

Optionally, the top cover includes a light panel and a pole, and a shortest distance between an encapsulated part of the pole and the light panel is 0.75 mm to 1.0 mm

A battery module is further provided in this disclosure, which includes a plurality of battery cores as described above; a frame for supporting the battery cores; a heat conducting plate provided between adjacent battery cores; and an air duct provided in a middle of the frame.

To sum up, the positive electrode plate and negative electrode plate of the charging and discharging assembly, the battery core and the battery module according to this disclosure are provided with at least two tabs and after all tabs are shifted to same sides of the positive and negative electrode plates, consistency can be increased, and technical prejudice of the skilled in the art can be overcome.

### BRIEF DESCRIPTION OF THE DRAWINGS

FIG. 1 is a schematic diagram of a positive electrode plate according to an embodiment of the present disclosure;

FIG. 2 is a schematic diagram of a negative electrode plate according to an embodiment of the present disclosure;

FIG. 3 is a partial enlarged view of an area A in FIG. 2;

FIG. 4 is a top view, a front view and a bottom view of the charging and discharging assembly according to an embodiment of this disclosure in sequence;

FIG. 5 is a front view and a schematic view of a section A-A of a positive connecting piece according to an embodiment of this disclosure;

FIG. 6 is a front view and a schematic view of a section B-B of a negative connecting piece according to an embodiment of this disclosure;

FIG. 7 is a schematic diagram of continuous laser welding of a charging and discharging assembly according to an embodiment of this disclosure;

FIG. 8 is a schematic diagram of butterfly welding of a charging and discharging assembly according to an embodiment of the disclosure;

FIG. 9 is a partial cross-sectional schematic view of a battery core after being installed in a case and the top cover according to an embodiment in the disclosure;

FIG. 10 is a top view of the battery core in FIG. 9;

FIG. 11 is a top view of more positive electrode plates provided according to an embodiment of this disclosure; and

FIG. 12 is a schematic diagram of a battery module according to an embodiment of this disclosure; and

FIG. 13 is an internal schematic view of a battery module with a part being removed according to an embodiment of this disclosure.

### DETAILED DESCRIPTION

In order to make the above and other objects, features and advantages of the disclosure more obvious and understandable, a detailed description is made below for the preferred embodiments with reference to the accompanying drawings.

### Embodiment 1

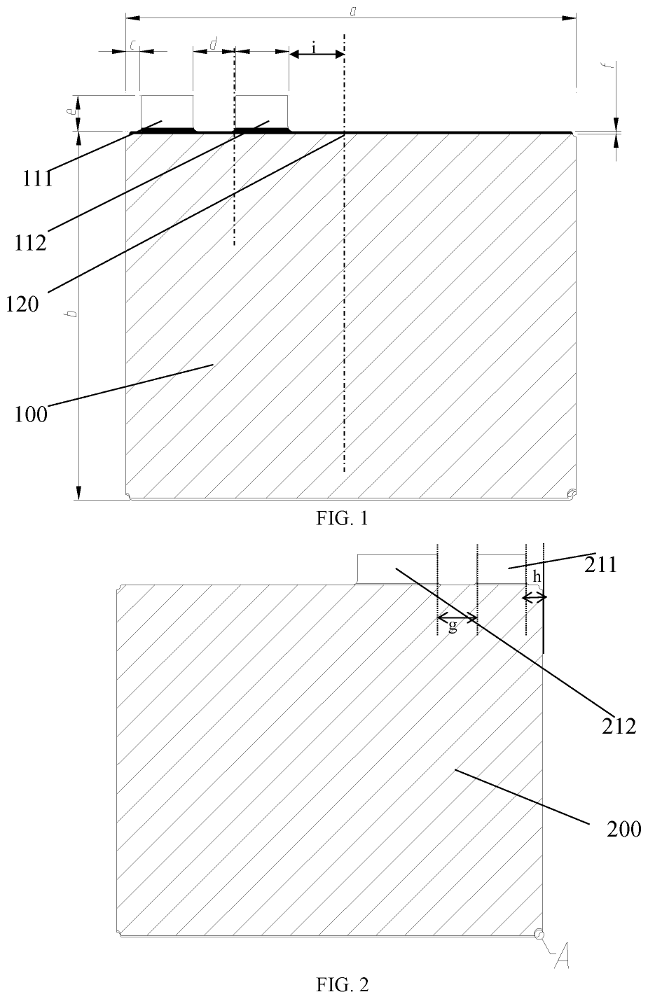

Referring to FIG. 1 to FIG. 4, a charging and discharging assembly applied in a lithium ion battery is provided in this disclosure. The charging and discharging unit 1 in this embodiment is with a wound core. The charging and discharging assembly includes a positive electrode plate 100 including positive tabs, a negative electrode plate 200 including negative tabs, and a separator for separating the positive electrode plate and the negative electrode plate. The positive tab at least includes a first positive tab 111 and a second positive tab 112, and the negative tab at least includes a first negative tab 211 and a second negative tab 212. The positive electrode plate, the separator and the negative electrode plate are stacked with each other. The positive tabs and the negative tabs are respectively shifted to same sides of the positive electrode plate and the negative electrode plate. With provision of this structure, uniformity of the charging and discharging assembly, the battery core and the like can be improved.

In this embodiment, the separator is a glued ceramic separator. The separator is with two sides, and one side is coated with functional ceramics (water-based glue+beta-alumina), and the other side is only with a glued layer, and the side coated with the functional ceramics is faced with the negative electrode plate and the glued layer is faced with the positive electrode plate. However, in other embodiments, the separator can also be made of other materials as long as it can function in insulating.

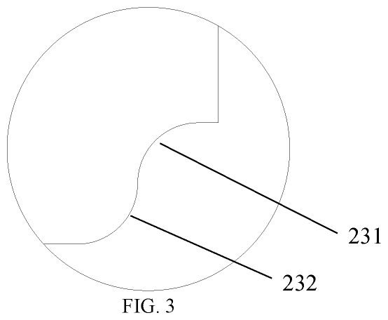

FIG. 1 shows a schematic diagram of a positive electrode plate. In this embodiment, the positive electrode plate is of a rectangular shape, and the tabs are also rectangular. Both the positive electrode plate and the negative electrode plate have a central axis. The central axis of the positive electrode plate is indicated by a longer dot-dash line in FIG. 1, and a wide side of the positive electrode plate extends along a top side of the positive electrode plate. The width of the positive electrode plate is indicated by a in FIG. 1, a height b of the positive electrode plate is parallel to the central axis of the positive electrode plate, and the central axis in this embodiment is a central symmetry line. In other embodiments, for example, if the electrode plate is in an asymmetric pattern, the central axis is a line passing through a midpoint of the wide side and perpendicular to the wide side, and when the wide side is uneven and non-linear, this line can be not perpendicular to the wide side, as long as it can serve to roughly distinguish connection areas of the positive tabs and the negative tabs. Of course, in some electrode plates with central symmetry, the central axis may not be a center line of symmetry, as long as it can serve to roughly distinguish areas for connecting the positive tabs and the negative tabs at a top side of the tab, and a height e of the tab is also shown in FIG. 1. FIG. 2 is a schematic diagram of the negative electrode plate, and a width and height direction of the negative electrode plate can be referred to the positive electrode plate.

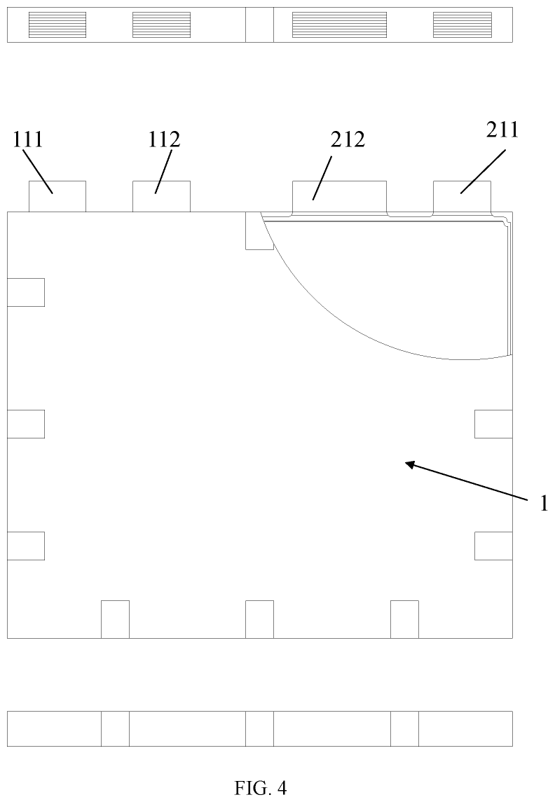

In this embodiment, the positive tabs are located at one same side of the central axis of the positive electrode plate and the negative tabs are located at the other side, opposite to the one side, of the central axis of the negative electrode plate, that is, after being stacked, the positive and negative tabs are respectively located at both sides of a central axis of the charging and discharging assembly, and the positive tabs and the negative tabs are respectively arranged along a top side of the positive electrode plate or negative electrode plate, and for example, as shown in FIG. 4, the first positive tab, the second positive tab, the second negative tab, and the second negative tab are arranged in sequence along a top side of an electrode plate.

In this embodiment, the positive tabs are shifted to one side of the central axis of the positive electrode plate, and the negative tabs are shifted to the other side, opposite to the one side, of the central axis of the negative electrode plate. More specifically, a central symmetry axis for all positive tabs is not coincident with a quarter axis of the positive electrode plate (indicated by a short dot-dash line in FIG. 1), and a central symmetry axis for all the negative tabs is not coincident with a quarter axis of the negative electrode plate. Further, the central symmetry axis for all the positive tabs is located at a side of the quarter axis of the positive electrode plate away from the negative tabs, and the central symmetry axis for all negative tabs is located at a side of the quarter axis of the negative electrode plate away from the positive tabs. In this embodiment, the quarter axis of the positive electrode plate is a symmetrical center line between an edge and the center axis of the electrode plate, and so is the quarter axis of the negative electrode plate. The quarter axis is defined in a manner similar to the center axis described above. In this embodiment, the central symmetry axis between the positive tabs lies at a half of a distance between the first positive tab and the second positive tab, and so does the central symmetry axis between the negative tabs. When there are more than two positive or negative tabs, if there are even number of tabs, the central symmetry axis is located at a half of a distance between the two middle tabs, and if there are odd number of tabs, the central symmetry axis is a symmetrical center line of a middle tab.

In this embodiment, the first positive tab is further away from the central axis of the positive electrode plate than the second positive tab, a distance between the first positive tab and the positive electrode plate is a first distance c, a distance between the first positive tab and the second positive tab is a second length d, the first length c is smaller than the second length d, and a distance between the first positive tab and an edge of the positive electrode plate is small.

In this embodiment, the distance between the second positive tab and the central axis of the positive electrode plate is a third length i, the second length is smaller than the third length, and a distance between the second positive tab and the central axis is large (relative to a distance between the first positive tab and the positive electrode plate).

In this embodiment, upon being stacked, the central axis of the positive electrode plate coincides with the central axis of the negative electrode plate, the first negative tab 211 is further away from the central axis of the negative electrode plate than the second negative tab 212, and the first negative tab and the first positive tab are symmetrically arranged to the central axis, and a gap between the first negative tab and the second negative tab is equal to the second length g, and a gap between the positive tabs is equal to a gap between the negative tabs, that is d is equal to g.

In this embodiment, widths of the first negative tab and the second negative tab are not the same, and the negative tab is larger in width near the central axis than that near an edge of the negative electrode plate, and the width of the second negative tab is larger than that of the first negative tab, and in this embodiment the width of the first negative tab is the same as those of the first positive tab and the second positive tab.

In this embodiment, chamfers are arranged at corners of the positive and negative electrode plates, and the chamfers is of a wavy structure, specifically including a concave arc 231 and a convex arc 232, which are sequentially connected, as shown in FIG. 3.

In this embodiment, there are two positive electrode plates and negative electrode plates, all the first positive tabs are electrically connected with each other, all the second positive tabs are electrically connected with each other, all the first negative tabs are electrically connected with each other, and all the second negative tabs are electrically connected with each other. Optionally, corresponding first positive tabs, second positive tabs, first negative tabs and second negative tabs to different positive or negative electrode plates are all the same, so the corresponding first positive tabs, second positive tabs, first negative tabs and second negative tabs are stacked to form a first positive tab group, a second positive tab group, a first negative tab group and a second negative tab group respectively. Hot pressing is adopted between the electrode plates, and welding or bonding can be performed between the tabs.

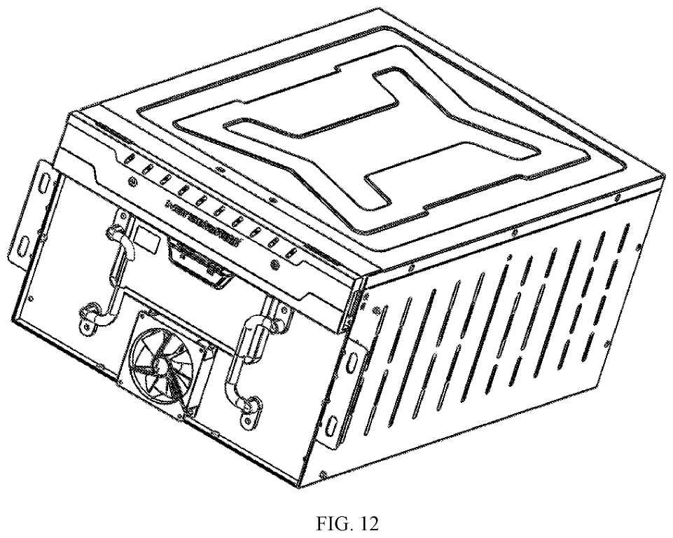

In this embodiment, as shown in FIG. 11, a top side of the positive electrode is provided with a ceramic insulating layer 120, and a connection area between a positive electrode and the positive electrode plate is not provided with the ceramic insulating layer, which indicates that the positive tab passes through the ceramic insulating layer to be connected with a main body of the positive electrode plate. A thickness f of the ceramic insulating layer is from 0.5 mm to 8 mm, which functions in insulation protection, so as to prevent positive die-cutting burr (insulation ceramic protection) of this electrode plate from contacting with other negative electrodes in the future, and avoid short circuit and fire caused by a bare aluminum foil contacting a negative SEI interface film. If the thickness of the ceramic insulating layer is provided to be too thick and exceeds a thickness of an electrode film, a thickness of the charging and discharging unit may be caused to increase, which will be difficult to be assembled into a case, thus squeezing the separator and being short-circuited.

In this embodiment, positive electrode plates, negative electrode plates and separators in a same charging and discharging assembly are all the same are all the same.

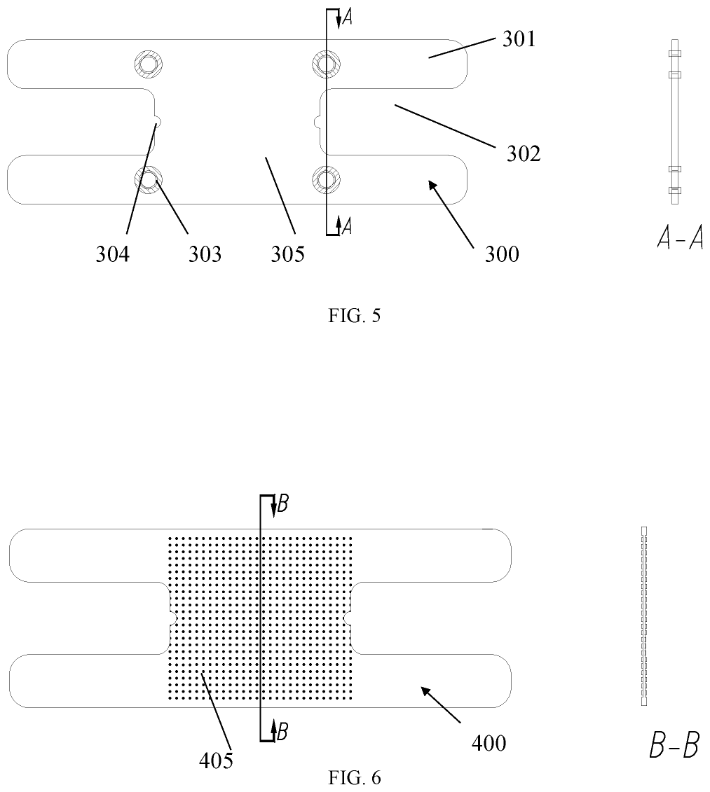

As shown in FIG. 5 to FIG. 10, a battery cored is further provided in this embodiment, which includes arbitrary two of the charging and discharging assemblies connected with each other, and a connecting piece for connecting different charging and discharging assemblies. The connecting piece includes a main region 305 and at least two connecting arms 301. The at least two connecting arms are electrically connected with the main region respectively, and at least one of the at least two connecting arms is connected with a positive tab or a negative tab of one 1 of the charging and discharging assemblies, and at least another of the at least two connecting arms is connected with a positive tab or a negative tab of the other 1′ of the charging and discharging assemblies.

In this embodiment, there are four connecting arms, and the four connecting arms extend from the main region, and two of the connecting arms are connected with one of the charging and discharging assemblies, and the other two of the connecting arms are connected with the other of the charging and discharging assemblies.

In this embodiment, the connecting pieces are all in a I-shape, but in other embodiments, they can be of any other shape, as long as it can be ensured that part of the connecting arms are connected with one of the charging and discharging assemblies, and other parts of the connecting arms or all of the rest connecting arms are connected with the other of the charging and discharging assemblies.

In this embodiment, two connecting arms connected with a same charging and discharging unit are located on a same straight line, and there is a gap 302 between connecting arms connected with different charging and discharging assemblies. In this embodiment, a width of the gap is larger than an arm width of the connecting arm, and in other embodiments, the width of the gap may be equal to or smaller than the arm width of the connecting arm. A length and width of the connecting arm are related to a size of the tab.

In this embodiment, a groove 304 is provided at a position of the main region corresponding to the gap, which can be engaged with a corresponding structural pin at a corresponding position of a cover plate, thus realizing positioning and fixing functions.

In this embodiment, a positive connecting piece is configured for connecting with the positive tab, and a fuse hole 303 is provided between the main region and the connecting arms of the connecting piece for the positive tab, and the fuse hole in this embodiment is covered with PEA.

In this embodiment, the connecting piece for the negative tab is configured for connecting with the negative tab, and the main region of the negative tab connecting piece is pitted, which can prevent cold joint caused by highly reflecting effect due to laser welding, thus improving welding effect and welding strength.

The four connecting arms of the positive connecting piece are respectively welded with the first positive electrode tab 111 and the second positive electrode tab 112 of the first charging and discharging unit 1, and the first positive electrode tab 111′ and the second positive electrode tab 112′ of the second charging and discharging unit 1′, and so are the negative connecting piece.

In this embodiment, a height of the positive tab is greater than a width of the connecting arm connected therewith.

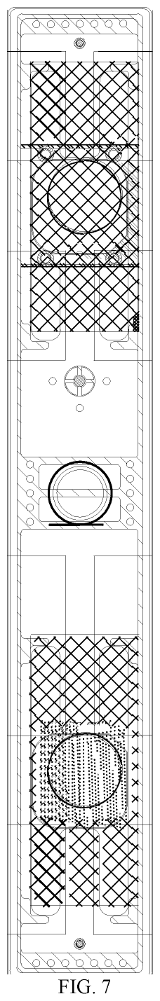

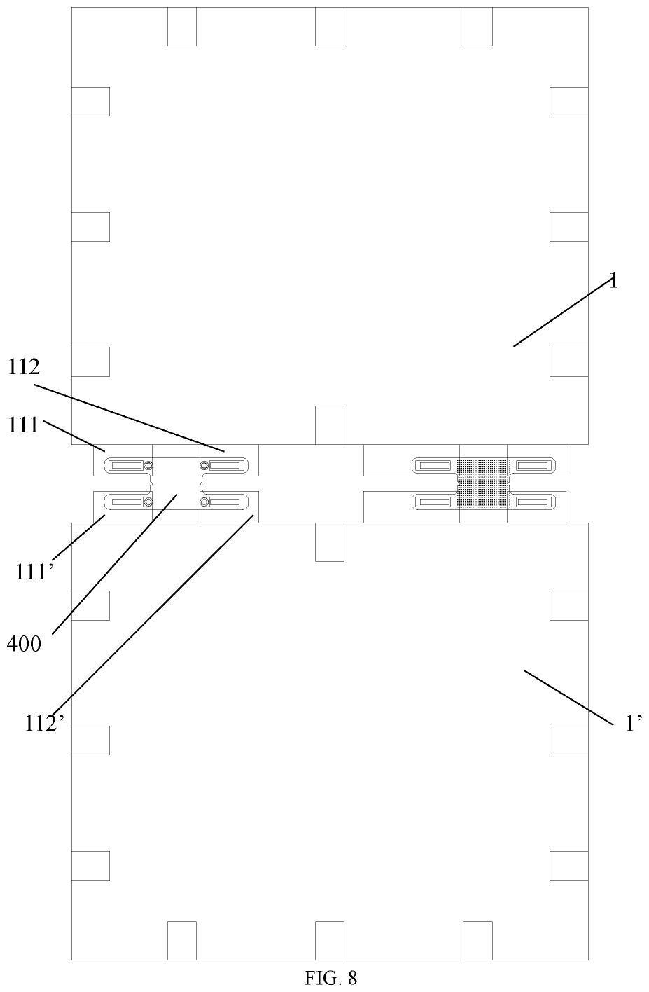

In this embodiment, the battery core further includes a top cover 500 and a case 600, more than two charging and discharging assemblies are connected by butterfly welding, the connecting piece is welded with the top cover, and the top cover is provided with a third-order platform liquid injection hole 503. Welding methods for more than two wound cores include butterfly welding and laser welding, as shown in FIGS. 7 and 8 respectively. A part of the electrode plate in FIG. 7 is not shown, and reference can be made to FIG. 8. After the connecting piece is welded with tabs of the two wound cores, the two wound cores can be bent and placed into the case.

In this embodiment, the top cover includes a light panel 504 and a pole, the pole can be divided into a positive pole 502 and a negative pole 501, and a shortest distance between an encapsulated part of the pole and the light panel is 0.75 mm to 1.0 mm, so as to ensure that a metal end of the pole with pole colloid fused and extended is kept at a safe distance from the light panel of the top cover in a case of short circuit. The pole is configured for electrically connecting with the main region of the connecting piece.

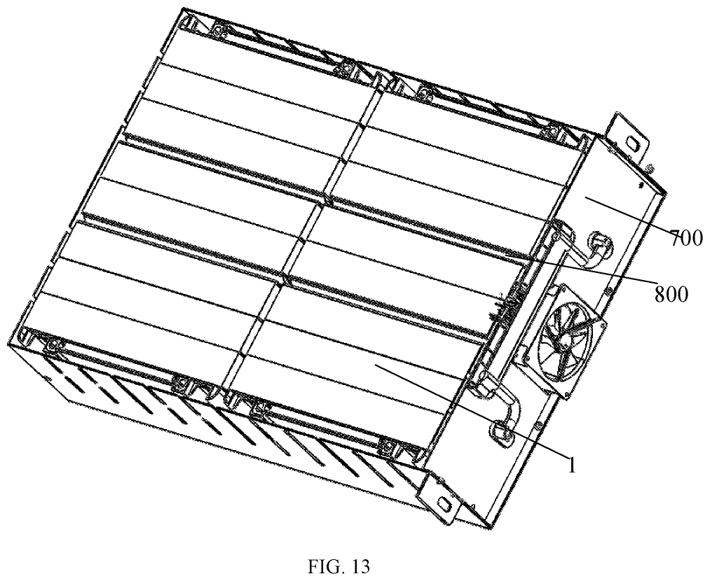

As shown in FIG. 12 and FIG. 13, a battery module is further provided in this embodiment, which includes: a plurality of battery cores 1 as described above, and the battery cores 1 being arranged in a matrix; a frame 700 for supporting the battery cores; a heat conducting plate provided between adjacent battery cores; and an air duct 800 provided in a middle of the frame. In this embodiment, an air-cooled battery module is shown, and in other embodiments, there may be also liquid-cooled battery modules.

### Embodiment 2

A battery core is provided in Embodiment 2, a basic structure of which is the same as that of Embodiment 1, and only differences are described below.

In the Embodiment 2, a density of the positive electrode plate is 410 g/m², and a formula of the positive electrode plate includes LFP: conductive agent: binder (wt %) with a ratio of 97%:0.5%:2.5% as a principal material, and a density of the negative electrode plate is 200 g/m² and a formula of the negative electrode plate is graphite:

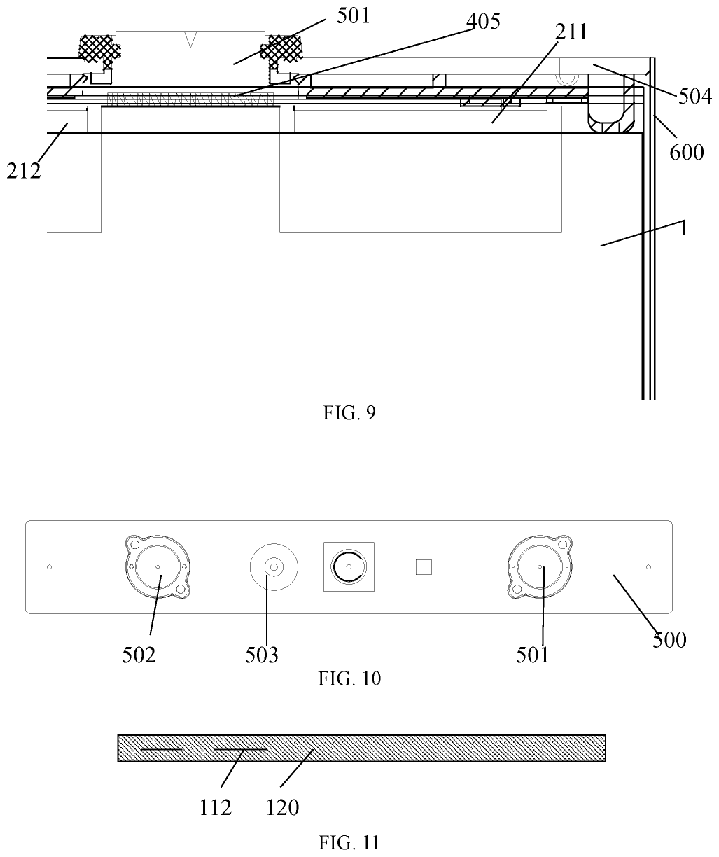

conductive agent: binder (wt %) with a ratio of 96.5%:1%:2 as a principal material. The separator includes a PE base membrane and a PVDF coated separator provided on both sides of the base membrane, and the PE base membrane is with a thickness of 12 microns. A thickness of the PVDF coated separator on each side is with a thickness of 0.5 micron, and a negative electrode, the separator, a positive electrode and the separator are sequentially stacked, and a tab is lead out of an end of one side. A number of layers of positive and negative electrodes of a single charging and discharging unit is 96/97, respectively (FIG. 4). Then a dry charging and discharging unit is formed from the two charging and discharging units by butterfly welding (FIG. 8). The dry charging and discharging unit is insulated by Mylar, then put into an aluminum case for primary laser sealing, then baked and subjected to primary liquid injection, formation and secondary liquid injection, for secondary sealing to form a battery core (FIG. 9).

Capacity grading is performed again on the battery core, a Hall current detector is provided at each negative terminal of the battery core so as to detect current consistency of each battery core in a charging-discharging state, and a current passing through each battery core is detected in a 0.5 C. constant current and constant voltage charging and discharging mode.

### Comparative Embodiment 1

It is basically the same as the battery core in the Embodiment 2, and only the differences are described below.

There are two positive and negative tabs in Comparative Embodiment 1, but one of the two tabs is arranged according to a position of the first tab (the first positive tab or the first negative tab) in Embodiment 2, and the other of the two tabs is arranged at a central axis of the electrode plate, that is, right in the middle, so are the positive and negative tabs.

### Comparative Embodiment 2

It is basically the same as the battery core in the Embodiment 2, and only the differences are described below.

There are two positive and negative tabs in Comparative Embodiment 2, but are symmetrically arranged at both sides of the central axis according to the second tab (second positive tab or second negative tab) in Embodiment 2.

### Comparative Embodiment 3

It is basically the same as the battery core in the Embodiment 2, and only the differences are described below.

There is only one positive and negative tab in Comparative Embodiment 3, but a width of positive tab is equal to a sum of all positive tabs in Embodiment 2, but a width of negative tab is equal to a sum of all negative tabs in Embodiment 2, and the positive tab is located in a middle between the first and second positive tabs in Embodiment 2, and the negative tab is located in a middle between the first and second negative tabs in Embodiment 2.

### Comparative Embodiment 4

It is basically the same as the battery core in the Embodiment 2, and only the differences are described below.

There are two positive and negative tabs in Comparative Embodiment 4, but are symmetrically arranged at both sides of the central axis according to the first tab (first positive tab or first negative tab) in Embodiment 2.

### Comparative Embodiment 5

It is basically the same as the battery core in the Embodiment 2, and only the differences are described below.

There are two positive and negative tabs in Comparative Embodiment 5, but one of the two tabs is arranged adjacent to an edge of the electrode plate, and the other of the two tabs is arranged at a central axis of the electrode plate, that is, right in the middle, so are the positive and negative tabs.

### Comparative Embodiment 6

It is basically the same as the battery core in the Embodiment 2, and only the differences are described below.

There is only one positive and negative tab in Comparative Embodiment 6, and both the positive and negative tabs are located at the central axis.

### Comparative Embodiment 7

It is basically the same as the battery core in the Embodiment 2, and only the differences are described below.

There is only one positive and negative tab in Comparative Embodiment 7. The positive tab is located at a position of the first positive tab in Embodiment 2, and the negative tab is located at a position of the first negative tab in Embodiment 2.

### Comparative Embodiment 8

It is basically the same as the battery core in the Embodiment 2, and only the differences are described below.

There is only one positive and negative tab in Comparative Embodiment 8. The positive tab is located at a position of the first second tab in Embodiment 2, and the negative tab is located at a position of the second negative tab in Embodiment 2.

Comparison of current bias values and grading capacities of the battery cores in Embodiment 2 and respective comparative embodiment can be referred in Table 1. It can be seen from Table 1 that a maximum current bias value of the 12 battery cores in Embodiment 2 is 143.6 A, a minimum current bias value is 139.6 A, with variance of 4 A, an average value of 141.217 A and a standard deviation of only 1.048676414, with a standard deviation significantly smaller than that of each comparative embodiment.

Therefore, charging and discharging provided by Embodiment 2 presents higher consistency.

TABLE 1
Comparison of current bias values and grading capacities of
battery cores in Embodiment 2 and Comparative Embodiments

| | | Battery core data | | | | | | | | |
|---|---|---|---|---|---|---|---|---|---|---|
| | | Battery | Battery | Battery | Battery | Battery | Battery | Battery | Battery | Battery |
| | Test | core | core | core | core | core | core | core | core | core |
| Item | items | 1# | 2# | 3# | 4# | 5# | 6# | 7# | 8# | 9# |
| Embodiment 2 | 0.5 C | 140.2 | 141.5 | 142.3 | 140.7 | 140.9 | 143.6 | 141.8 | 140.9 | 140.5 |
| | monitored | | | | | | | | | |
| | current | | | | | | | | | |
| | bias | | | | | | | | | |
| | value/A | | | | | | | | | |
| | Grading | 296.5 | 296.8 | 295.3 | 294.9 | 296.5 | 297.9 | 296.6 | 296.8 | 296.1 |
| | Capacity | | | | | | | | | |
| | of | | | | | | | | | |
| | Battery | | | | | | | | | |
| | Core/Ah | | | | | | | | | |
| Comparative | 0.5 C | 135.5 | 140.7 | 136.9 | 137 | 136.9 | 130.6 | 132.3 | 143.2 | 142.5 |
| Embodiment 1 | monitored | | | | | | | | | |
| | current | | | | | | | | | |
| | bias | | | | | | | | | |
| | value/A | | | | | | | | | |
| | Grading | 292.6 | 298.4 | 290.6 | 289.2 | 285.2 | 285.6 | 284.2 | 284.5 | 286.7 |
| | Capacity | | | | | | | | | |
| | of | | | | | | | | | |
| | Battery | | | | | | | | | |
| | Core/Ah | | | | | | | | | |
| Comparative | 0.5 C | 130.1 | 135.4 | 133.9 | 132.2 | 136.9 | 128.4 | 136.9 | 136.7 | 138.9 |
| Embodiment 2 | monitored | | | | | | | | | |
| | current | | | | | | | | | |
| | bias | | | | | | | | | |
| | value/A | | | | | | | | | |
| | Grading | 293.3 | 294.9 | 296.5 | 289.6 | 290.3 | 293.7 | 293.9 | 293.4 | 293.4 |
| | Capacity | | | | | | | | | |
| | of | | | | | | | | | |
| | Battery | | | | | | | | | |
| | Core/Ah | | | | | | | | | |
| Comparative | 0.5 C | 130.7 | 135.3 | 138.3 | 135.5 | 134.7 | 135.6 | 131.6 | 133.7 | 134.6 |
| Embodiment 3 | monitored | | | | | | | | | |
| | current | | | | | | | | | |
| | bias | | | | | | | | | |
| | value/A | | | | | | | | | |
| | Grading | 295.8 | 293.2 | 294.7 | 295.1 | 293.3 | 291.9 | 294.8 | 295.9 | 294.8 |
| | Capacity | | | | | | | | | |
| | of | | | | | | | | | |
| | Battery | | | | | | | | | |
| | Core/Ah | | | | | | | | | |
| Comparative | 0.5 C | 145.9 | 143.6 | 145.6 | 147.2 | 149.6 | 146.6 | 141.1 | 150.6 | 148.5 |
| Embodiment 4 | monitored | | | | | | | | | |
| | current | | | | | | | | | |
| | bias | | | | | | | | | |
| | value/A | | | | | | | | | |
| | Grading | 284.1 | 288.2 | 284.2 | 288.3 | 280.8 | 284.1 | 284.6 | 284.9 | 284 |
| | Capacity | | | | | | | | | |
| | of | | | | | | | | | |
| | Battery | | | | | | | | | |
| | Core/Ah | | | | | | | | | |
| Comparative | 0.5 C | 134 | 141.8 | 137.6 | 137 | 136.8 | 130.4 | 131.2 | 142.9 | 141.8 |
| Embodiment 5 | monitored | | | | | | | | | |
| | current | | | | | | | | | |
| | bias | | | | | | | | | |
| | value/A | | | | | | | | | |
| | Grading | 293.1 | 298.2 | 291.1 | 289.5 | 286.8 | 286.6 | 284.7 | 285.6 | 287.9 |
| | Capacity | | | | | | | | | |
| | of | | | | | | | | | |
| | Battery | | | | | | | | | |
| | Core/Ah | | | | | | | | | |
| Comparative | 0.5 C | 130.3 | 150.3 | 133.2 | 153.1 | 133.2 | 153.1 | 133.2 | 153.1 | 133.2 |
| Embodiment 6 | monitored | | | | | | | | | |
| | current | | | | | | | | | |
| | bias | | | | | | | | | |
| | value/A | | | | | | | | | |
| | Grading | 293.3 | 284.9 | 293.6 | 284.3 | 293.4 | 284.6 | 293.5 | 284.8 | 293.2 |
| | Capacity | | | | | | | | | |
| | of | | | | | | | | | |
| | Battery | | | | | | | | | |
| | Core/Ah | | | | | | | | | |
| Comparative | 0.5 C | 134.3 | 151.3 | 134.6 | 151.3 | 134.3 | 151.1 | 134.1 | 151.7 | 134.6 |
| Embodiment 7 | monitored | | | | | | | | | |
| | current | | | | | | | | | |
| | bias | | | | | | | | | |
| | value/A | | | | | | | | | |
| | Grading | 295.3 | 283.9 | 295.4 | 283.9 | 295.1 | 283.4 | 295.3 | 283.9 | 295.3 |
| | Capacity | | | | | | | | | |
| | of | | | | | | | | | |
| | Battery | | | | | | | | | |
| | Core/Ah | | | | | | | | | |
| Comparative | 0.5 C | 136.5 | 148.5 | 136.2 | 148.6 | 136.4 | 148.5 | 136.8 | 148.9 | 136.5 |
| Embodiment 8 | monitored | | | | | | | | | |
| | current | | | | | | | | | |
| | bias | | | | | | | | | |
| | value/A | | | | | | | | | |
| | Grading | 293.6 | 287.7 | 293.1 | 287.4 | 293.4 | 287.6 | 293.6 | 287.5 | 293.7 |
| | Capacity | | | | | | | | | |
| | of | | | | | | | | | |
| | Battery | | | | | | | | | |
| | Core/Ah | | | | | | | | | |

| | | Battery core data | | | | | | |
|---|---|---|---|---|---|---|---|---|
| | | Battery | Battery | Battery | | | | |
| | Test | core | core | core | | | | Standard |
| Item | items | 10# | 11# | 12# | Maximum | Minimum | Average | Deviation |
| Embodiment 2 | 0.5 C | 142.1 | 139.6 | 140.5 | 143.6 | 139.6 | 141.217 | 1.048676414 |
| | monitored | | | | | | | |
| | current | | | | | | | |
| | bias | | | | | | | |
| | value/A | | | | | | | |
| | Grading | 296.3 | 296.4 | 295.5 | 297.9 | 294.9 | 296.3 | 0.757187779 |
| | Capacity | | | | | | | |
| | of | | | | | | | |
| | Battery | | | | | | | |
| | Core/Ah | | | | | | | |
| Comparative | 0.5 C | 138.9 | 140.1 | 140.3 | 143.2 | 130.6 | 137.908 | 3.673204399 |
| Embodiment 1 | monitored | | | | | | | |
| | current | | | | | | | |
| | bias | | | | | | | |
| | value/A | | | | | | | |
| | Grading | 284.1 | 297.6 | 296.6 | 298.4 | 284.1 | 289.608 | 5.242368792 |
| | Capacity | | | | | | | |
| | of | | | | | | | |
| | Battery | | | | | | | |
| | Core/Ah | | | | | | | |
| Comparative | 0.5 C | 131.6 | 128.9 | 130.3 | 138.9 | 128.4 | 133.35 | 3.419186063 |
| Embodiment 2 | monitored | | | | | | | |
| | current | | | | | | | |
| | bias | | | | | | | |
| | value/A | | | | | | | |
| | Grading | 293.2 | 293.1 | 293.4 | 296.5 | 289.6 | 293.225 | 1.732591989 |
| | Capacity | | | | | | | |
| | of | | | | | | | |
| | Battery | | | | | | | |
| | Core/Ah | | | | | | | |
| Comparative | 0.5 C | 135.7 | 135.1 | 133 | 138.3 | 130.7 | 134.483 | 1.933836142 |
| Embodiment 3 | monitored | | | | | | | |
| | current | | | | | | | |
| | bias | | | | | | | |
| | value/A | | | | | | | |
| | Grading | 292.9 | 292.8 | 295.4 | 295.9 | 291.9 | 294.217 | 1.272028127 |
| | Capacity | | | | | | | |
| | of | | | | | | | |
| | Battery | | | | | | | |
| | Core/Ah | | | | | | | |
| Comparative | 0.5 C | 149.6 | 142.4 | 145.6 | 150.6 | 141.1 | 146.358 | 2.837974141 |
| Embodiment 4 | monitored | | | | | | | |
| | current | | | | | | | |
| | bias | | | | | | | |
| | value/A | | | | | | | |
| | Grading | 286 | 282.6 | 281.9 | 288.3 | 280.8 | 284.475 | 2.145974914 |
| | Capacity | | | | | | | |
| | of | | | | | | | |
| | Battery | | | | | | | |
| | Core/Ah | | | | | | | |
| Comparative | 0.5 C | 139.1 | 141.2 | 140.38 | 142.9 | 130.4 | 137.848 | 4.003419025 |
| Embodiment 5 | monitored | | | | | | | |
| | current | | | | | | | |
| | bias | | | | | | | |
| | value/A | | | | | | | |
| | Grading | 284.5 | 298.1 | 297.9 | 298.2 | 284.5 | 290.333 | 5.073679357 |
| | Capacity | | | | | | | |
| | of | | | | | | | |
| | Battery | | | | | | | |
| | Core/Ah | | | | | | | |
| Comparative | 0.5 C | 153.1 | 133.2 | 153.1 | 153.1 | 130.3 | 142.675 | 10.01483275 |
| Embodiment 6 | monitored | | | | | | | |
| | current | | | | | | | |
| | bias | | | | | | | |
| | value/A | | | | | | | |
| | Grading | 284.6 | 293.4 | 284.5 | 293.6 | 284.3 | 289.008 | 4.39478068 |
| | Capacity | | | | | | | |
| | of | | | | | | | |
| | Battery | | | | | | | |
| | Core/Ah | | | | | | | |
| Comparative | 0.5 C | 151 | 134.1 | 151.3 | 151.7 | 134.1 | 142.808 | 8.477662643 |
| Embodiment 7 | monitored | | | | | | | |
| | current | | | | | | | |
| | bias | | | | | | | |
| | value/A | | | | | | | |
| | Grading | 283.9 | 295.3 | 283.8 | 295.4 | 283.4 | 289.542 | 5.743468513 |
| | Capacity | | | | | | | |
| | of | | | | | | | |
| | Battery | | | | | | | |
| | Core/Ah | | | | | | | |
| Comparative | 0.5 C | 148.7 | 136.1 | 148 | 148.9 | 136.1 | 142.475 | 6.063569493 |
| Embodiment 8 | monitored | | | | | | | |
| | current | | | | | | | |
| | bias | | | | | | | |
| | value/A | | | | | | | |
| | Grading | 287.7 | 293.6 | 287.7 | 293.7 | 287.4 | 290.55 | 2.954516317 |
| | Capacity | | | | | | | |
| | of | | | | | | | |
| | Battery | | | | | | | |
| | Core/Ah | | | | | | | |

It should be understood by those skilled in the art that in the disclosure of the present invention, the orientation or positional relationship indicated by the terms “upper”, “lower”, “front”, “rear”, “left”, “right”, “vertical”, “horizontal”, “top”, “bottom”, “inner”, “inner” and the like is based on the orientation or positional relationship shown in the drawings, which is only for the convenience of describing the disclosure and simplifying the description, but does not indicate or imply that the referred device or element must have a specific orientation, be constructed and operated in a specific orientation, and thus the above terms cannot be understood as limiting the disclosure.

Although the disclosure has been disclosed by the preferred embodiment in the above, it is not intended to limit the disclosure and any person familiar with the art can make some changes and embellishments without departing from the spirit and scope of the disclosure; therefore, the scope of protection of the disclosure should be subject to a scope of protection as claimed in the claims.

What is claimed is:

1. A charging and discharging assembly applied in a lithium ion battery, comprising:
a positive electrode plate comprising positive tabs, the positive tabs at least comprising a first positive tab and a second positive tab which are electrically connected with each other;
a negative electrode plate comprising negative tabs, the negative tabs at least comprising a first negative tab and a second negative tab which are electrically connected with each other, and
a separator for separating the positive electrode plate and the negative electrode plate;
wherein the positive electrode plate, the separator and the negative electrode plate are stacked with each other; and
wherein the positive tabs comprising at least the first positive tab and the second positive tab are shifted to one side of the positive electrode plate, and the negative tabs comprising at least the first negative tab and the second negative tab is shifted to one side of the negative electrode plate, and the positive tabs and the negative tabs are both located at a same end of the stacked positive and negative electrode plates.

2. The charging and discharging assembly according to claim 1, wherein both the positive and negative electrode plates have a central axis, and the positive tabs are located at one side of the central axis of the positive electrode plate and the negative tabs are located at the other side, opposite to the one side, of the central axis of the negative electrode plate, and the positive tabs and the negative tabs are respectively arranged in sequence along a top side of the positive electrode plate or negative electrode plate.

3. The charging and discharging assembly according to claim 2, wherein the positive tabs are shifted to one side of the central axis of the positive electrode plate, and the negative tabs are shifted to the other side, opposite to the one side, of the central axis of the negative electrode plate.

4. The charging and discharging assembly according to claim 3, wherein the first positive tab is further away from the central axis of the positive electrode plate than the second positive tab, a distance between the first positive tab and the positive electrode plate is a first distance, a distance between the first positive tab and the second positive tab is a second length, the first length being smaller than the second length; and a distance between the second positive tab and the central axis of the positive electrode plate is a third length, the second length being smaller than the third length.

5. The charging and discharging assembly according to claim 3, wherein upon being stacked, the central axis of the positive electrode plate coincides with the central axis of the negative electrode plate, the first negative tab is further away from the central axis of the negative electrode plate than the second negative tab; the first negative tab and the first positive tab are symmetrically arranged to the central axis; and a gap between the positive tabs is equal to a gap between the negative tabs.

6. The charging and discharging assembly according to claim 5, wherein widths of the first negative tab and the second negative tab are different.

7. The charging and discharging assembly according to claim 6, wherein the negative tab is larger in width near the central axis than near an edge of the negative electrode plate.

8. The charging and discharging assembly according to claim 1, wherein there are a plurality of positive electrode plates and negative electrode plates, all the first positive tabs are electrically connected with each other, all the second positive tabs are electrically connected with each other, all the first negative tabs are electrically connected with each other, and all the second negative tabs are electrically connected with each other.

9. The charging and discharging assembly according to claim 2, wherein a top side of the positive electrode is provided with a ceramic insulating layer, with a thickness from 0.5 mm to 8 mm.

10. A battery core, comprising more than two charging and discharging assemblies according to claim 1, and a connecting piece for connecting different charging and discharging assemblies, wherein the connecting piece comprises:
a main region, and
at least two connecting arms electrically connected with the main region respectively, wherein at least one of the at least two connecting arms is connected with a positive tab or a negative tab of one of the charging and discharging assemblies, and at least another of the at least two connecting arms is connected with a positive tab or a negative tab of another of the charging and discharging assemblies.

11. The battery core according to claim 10, wherein there are four connecting arms, the four connecting arms extending from the main region, and two of the connecting arms being connected with one of the charging and discharging assemblies, and the other two of the connecting arms being connected with the other of the charging and discharging assemblies.

12. The battery core according to claim 11, wherein two connecting arms connected with a same charging and discharging unit are located on a same straight line, and there is a gap between connecting arms connected with different charging and discharging assemblies.

13. The battery core according to claim 12, wherein a groove is provided at a position of the main region corresponding to the gap.

14. The battery core according to claim 10, wherein a positive connecting piece is configured for connecting with the positive tab, and a fuse hole is provided between the main region and the connecting arms of the connecting piece for the positive tab.

15. The battery core according to claim 10, wherein the connecting piece for the negative tab is configured for connecting with the negative tab, and the main region of the negative tab connecting piece is pitted.

16. The battery core according to claim 10, wherein a height of the positive tab is greater than a width of the connecting arm connected therewith.

17. The battery core according to claim 10, wherein the battery core further comprises a top cover, more than two charging and discharging assemblies are connected by butterfly welding, the connecting piece is welded with the top cover, and the top cover is provided with a third-order platform liquid injection hole.

18. The battery core according to claim 17, wherein the top cover comprises a light panel and a pole, and a shortest distance between an encapsulated part of the pole and the light panel is 0.75 mm to 1.0 mm.

19. A battery module, comprising:
a plurality of battery cores according to claim 10;
a frame for supporting the battery cores;
a heat conducting plate provided between adjacent battery cores; and
an air duct provided in a middle of the frame.
